(19) United States
(12) Patent Application Publication
(10) Pub. No.: US 2008/0080950 A1
(43) Pub. Date: Apr. 3, 2008

(54) I and T combo

(76) Inventor: Stephen David Lehman, Huntsville (CA)

Correspondence Address: Stephen D. Lehman, 1007 Millar Hill Rd., R.R. #4, Huntsville, ON, P1H 2J6, CA

(21) Appl. No.: 11/973,228

(22) Filed: Oct. 9, 2007

(30) Foreign Application Priority Data
Jul. 25, 2006 (CA) 2,555,504

(51) Int. Cl. F16B 25/00; F16B 35/04; F16B 43/00

(52) U.S. Cl. 411/386; 411/531

(57) ABSTRACT

In relation to a nut and bolt combination that can fasten together a myriad of objects, one constant has remained the same; the nut must be threaded on to or off of the bolt to facilitate the proper employment of the two complementary devices. Oftentimes this can be a tedious, time consuming exercise. In this invention, a nut, unique bolt and unique washer combination work as one unit to facilitate the speedy removal and reinstatement, respectively, of said nut, bolt and washer from and to any two or more objects meant to be joined together by use of such a device.

### CROSS-REFERENCE TO RELATED APPLICATIONS

N/A

### STATEMENT REGARDING FEDERALLY SPONSORED R. OR D

N/A

### REFERENCE TO SEQUENCE LISTING

N/A

### BACKGROUND OF THE INVENTION

This invention relates to a quick release nut, bolt and washer combination that can fasten together many of two or more objects that normally are joined by means of a nut and bolt combination alone.

In the pursuit of firmly joining together two or more objects without the use of a bonding agent, clamp, extreme heat or other such measure, one popular method is to drill a hole through the two objects to be joined, if none already exist, and insert the threaded portion of a bolt, with a diameter slightly less than the circumference of the holes and of sufficient length to protrude past the combined thickness of the two or more aligned holes, through the two or more holes until the head of the bolt, with a diameter larger than that of the threaded portion of the bolt and larger than the circumference of the hole, encounters the surface of one of the objects, thereby arresting any further travel of the bolt through the hole in the object. Once this occurs, the hole in a nut with a thread pattern identical to that of the bolt is aligned on the tip of the bolt and rotated, normally in a clockwise direction relative to the head of the bolt, on a plane perpendicular to that of the longitude of the bolt until the nut encounters the surface of the object, or objects, intended to be joined to the other at which point sufficient torque is applied to the nut and the stationary bolt to mate all the adjoining surfaces together, sometimes with enough force that none of the objects can overcome the resistance generated by their respective surfaces and thus vary their position, or sometimes not. Although extremely effective by virtue of its extreme simplicity and variability vis-a-vis the bolt's infinite permutations of length and diameter, a nut and bolt combination, in certain situations, can be excessive for the job required of them and in other situations the interaction of natures elements conspire to transform a fixture comprised of two separate entities—i.e. —a nut and a bolt—into one, solid piece of rusted metal that can be difficult, if not impossible, to separate back into two individual pieces due to the process of oxidation eventually creating a permanent bond wherever iron touches iron, particularly if the iron is bare.

### BRIEF SUMMARY OF THE INVENTION

The substance of this invention is ease of use. Whereas a traditional nut and bolt combination can be tedious and time consuming to implement, the I and T combo, combined with an ordinary threaded nut, is easy and quick to engage or disengage, a ¼ turn of the T bolt relative to the stationary I washer being all that is required to allow the two pieces, and anything being held in place by them, to be separated. Engagement is almost as easy, as all that is necessary to employ the two pieces is insertion of the T bolt tip, after passing through the designated holes a length of T bolt sufficient to exit the combined depth of the objects being joined, through the orifice in the I washer, followed by a ¼ turn of the T bolt relative to the stationary I washer, followed by a number of rotations of the nut on the stationary T bolt in a direction designed to advance the nut toward the I washer and any objects in between until the nut eventually creates enough compression to hold all pieces involved firmly in place.

### BRIEF DESCRIPTION OF THE SEVERAL VIEWS OF THE DRAWING

In drawings which illustrate the embodiments of this invention,

FIG. 1 depicts the threaded T bolt 2 in an upright position with the tensioning nut 1 positioned just forward of the head of the T bolt and the top member of the T pattern indicated by the number 3 while

FIG. 2 depicts the same T bolt after being rotated 90 degrees on a plane perpendicular to its longitudinal axis and

FIG. 3 depicts a horizontal plane view of the I washer as indicated by the number 4 while

FIG. 4 depicts an elevated view of the same washer lying flat on a corresponding flat surface, solid area of the I washer represented by hatching, creating a rectangular orifice as indicated by the number 5.

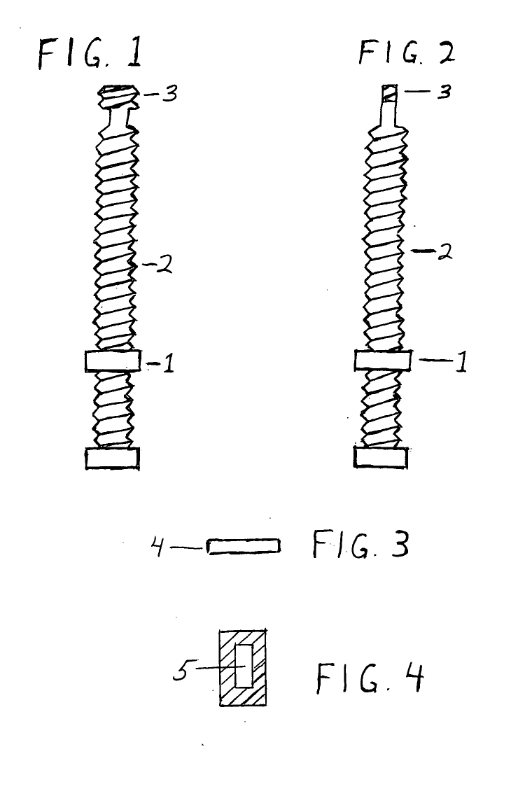

### DETAILED DESCRIPTION OF THE INVENTION

By molding, casting or machining, I have been able to create a uniquely designed threaded bolt and flat washer that, in conjunction with an ordinary threaded nut, improve upon the usability and functionality of the ubiquitous nut and bolt combination employed throughout the world. To accomplish this, I began by reassigning the job normally performed by the nut on the end of the bolt to a uniquely designed rectangular washer and by reconfiguring the tip end of the bolt itself into a shape identical to that of an English alphabet capital T with a solid, or hollow, unthreaded cylindrical shaped base of a slightly smaller diameter than the threaded portion of the T bolt but continuing along the same longitudinal plane as said threaded portion and a solid, or hollow, rectangular top member, either cylindrical or with all of its angles being right angles, running on a plane perpendicular to that of its base with a length identical to that of the diameter of the threaded portion of the T bolt, the opposing ends of the top member length having a thread pattern on their face identical to that of the threaded portion of the bolt.

By rotating the bolt 90 degrees on a plane perpendicular to its longitudinal axis, the T now looks like an English alphabet capital I of two dimensional rectangular shape running on the same longitudinal axis as the treaded portion of the bolt, identical in diameter to but appearing slightly longer than the base of the T appeared because this second view does not present any opposing angles to differentiate the top member from the base. The flat I washer that complements this T bolt has an interior orifice rectangular in shape when lying flat on a flat surface and viewed from above, as opposed to the circular interior pattern normally associated with washers, that is marginally longer than the length and marginally wider than the width of the top member of the T pattern on the T bolt tip.

To make proper use of this invention, the T bolt must be of sufficient length for the threaded portion, with nut 1 positioned adjacent to the T bolt head, to protrude at least marginally through the combined depth of the holes in the two or more objects to be fastened together while the base of the T pattern should be marginally longer than the thickness of the I washer to be affixed to it but not so long as to be greater than the combined depth of the two or more objects to be secured together. After inserting the body of the T bolt into and through the designated holes in any and all objects, the top member 3 on the tip of the T bolt is aligned and inserted through the rectangular orifice 5 in the I washer until the entire three-dimensions of the top member 3 have passed through the orifice 5 and then either the T bolt or the I washer are rotated ¼ turn on a plane perpendicular to the longitude of the T bolt so that the length of the top member 3 is now at a right angle to the length of the orifice in the I washer, the lengths of both top member 3 and orifice 5 being greater than their respective widths, at which point in the sequence nut 1 is rotated in a direction designed to move it away from the head of the T bolt and toward the I washer, effectively compressing the intended objects together in the same manner as a commonly recognized nut and bolt combination. The improvement provided by the I washer and the T bolt to the aforementioned combination is that by the simple maneuver of rotating the utilized T bolt 90 degrees on a plane perpendicular to its longitudinal axis, disengagement from the stationary I washer can be accomplished and the objects thus separated. By rotating nut 1 in a direction designed to move it partially back towards the head of the T bolt, the T bolt is now ready to be reinstated in its previous application or reused in a new but similar circumstance. Also, since the surface area of the top member of the T pattern that contacts the surface area of the I washer is less than that normally encountered by the interlocking threads of a regular steel nut and bolt, the area affected by the rusting process that can make steel nuts and bolts so hard to separate is greatly diminished, making removal after an extended period of time less difficult.

What I claim as my invention is:

1- A unique bolt whose tip appears from a certain view to terminate with a right-angled cross-member akin to the horizontal cross-member found on the top of a capital letter T in the English alphabet, the cross-member having face ends on its length threaded identically to the thread pattern on the main body of the bolt and a length greater than its width and equal to the diameter of the threaded portion of the bolt and at a right angle to a base with a circumference marginally less than the circumference of the threaded portion of the bolt and a length marginally greater than the depth of the unique washer with which it will be mated, creating a bolt that when rotated 90 degrees on a plane perpendicular to its longitude will allow it to engage with or disengage from the stationary unique washer when being employed as per design with said washer.

2- A unique washer whose interior orifice is rectangular as opposed to circular when viewed from above while lying flat on a flat surface and is scaled to be compatible to a unique bolt, acting as a retaining plate to anchor said unique bolt against the pressure exerted by an ordinary nut threaded onto said unique bolt and torqued against the washer and/or anything in between.
